(19) United States
(12) Patent Application Publication
(10) Pub. No.: US 2021/0352777 A1
(43) Pub. Date: Nov. 11, 2021

(54) MICROWAVE PROCESSING DEVICE

(71) Applicant: Panasonic Intellectual Property Management Co., Ltd., Osaka (JP)

(72) Inventors: YOSHIHARU OOMORI, Shiga (JP); MIKIO FUKUI, Shiga (JP); DAISUKE HOSOKAWA, Shiga (JP)

(21) Appl. No.: 17/052,968

(22) PCT Filed: May 15, 2019
(86) PCT No.: PCT/JP2019/019200

§ 371 Date: Nov. 4, 2020

(30) Foreign Application Priority Data
May 21, 2018 (JP) 2018-096702
May 21, 2018 (JP) 2018-096703

(51) Int. Cl. H05B 6/68; H05B 6/70; H05B 6/72

(52) U.S. Cl. CPC H05B 6/68; H05B 6/72; H05B 6/70

(57) ABSTRACT

A microwave treatment device includes a plurality of radiation parts, a transmission line, and a plurality of feeding parts. The plurality of radiation parts includes first, second, and third radiation parts, and radiates a microwave. The transmission line has a loop line structure provided with a plurality of branch parts including first, second, and third branch parts, and transmits the microwave to the first, second, and third radiation parts respectively connected to the first, second, and third branch parts. The plurality of feeding parts includes the first feeding part and the second feeding part arranged in the transmission line at an interval of ¼ or less of the wavelength of the microwave, and transmits the microwave to the transmission line. According to this aspect, a radiation part that radiates the microwave can be selectively switched. This enables the intended heating distribution to be achieved.

### TECHNICAL FIELD

The present disclosure relates to a microwave treatment device for heating a heating target object accommodated in a heating chamber.

### BACKGROUND ART

Conventionally, microwave treatment devices include those equipped with a plurality of rotation antennas (see, for example, PTL 1). A microwave treatment device described in PTL 1 aims to reduce uneven heating by radiating microwaves to a wide area inside a heating chamber by means of a plurality of rotation antennas.

Conventional technologies include a microwave treatment device including a plurality of radiation parts radiating microwaves and configured to control a phase difference of the microwaves radiated from the plurality of radiation parts (see, for example, PTL 2). The microwave treatment device described in PTL 2 aims to change microwave distribution by controlling a phase difference, thus performing uniform heating and intensive heating.

### CITATION LIST

### Patent Literature

PTL 1: Japanese Patent Application Unexamined Publication No. 2004-47322

PTL 2: Japanese Patent Application Unexamined Publication No. 2008-66292

### SUMMARY OF THE INVENTION

However, with the microwave treatment device described in PTL 1, the microwave distribution does not much vary. With the microwave treatment device described in PTL 2, it is difficult to carry out desired heat treatment on objects to be heated having various shapes, types, and amounts.

That is to say, even if a phase difference is controlled, a standing wave moves only by about half a wavelength, and the microwave distribution does not much vary. Even if a plurality of microwaves are spatially synthesized to control the microwave distribution in a heating chamber, the microwave distribution itself changes due to an influence of the heating target object. Consequently, the intended heating cannot be reproduced. When a plurality of radiation parts is operated or stopped, radiation positions are largely displaced, thus enabling the microwave distribution to largely vary. However, supplied electric power becomes smaller, and cooking time becomes longer.

The present disclosure has been made in view of the above-mentioned problems. An object of the present disclosure is to provide a microwave treatment device capable of heating objects to be heated having various shapes, types, and amounts into a desired state for a short time.

A microwave treatment device in accordance with one aspect of the present disclosure includes a plurality of radiation parts, a transmission line, and a plurality of feeding parts. The plurality of radiation parts includes a first radiation part, a second radiation part, and a third radiation part, and radiates a microwave. The transmission line has a loop line structure provided with a plurality of branch parts including a first branch part, a second branch part, and a third branch part. The transmission line transmits the microwave to the first radiation part, the second radiation part, and the third radiation part respectively connected to the first branch part, the second branch part, and the third branch part. The plurality of feeding parts includes the first feeding part and the second feeding part arranged in the transmission line at an interval of ¼ or less of a wavelength of the microwave, and transmits the microwave to the transmission line.

According to this aspect, a radiation part that radiates the microwave can be selectively switched. This enables the intended heating distribution to be achieved. As a result, objects to be heated having various shapes, types, and amounts can be heated into a desired state for a short time.

### BRIEF DESCRIPTION OF DRAWINGS

FIG. 1 is a schematic diagram showing a configuration of a microwave treatment device in accordance with a first exemplary embodiment of the present disclosure.

FIG. 2 is a schematic diagram showing a configuration and a line length of a transmission line in the microwave treatment device in accordance with the first exemplary embodiment.

FIG. 3 is a schematic diagram showing a configuration and a line length of the transmission line in the microwave treatment device in accordance with the first exemplary embodiment.

FIG. 4 is a perspective view of the transmission line in the microwave treatment device in accordance with the first exemplary embodiment.

FIG. 5 is a schematic diagram showing a configuration of a transmission line in a microwave treatment device in accordance with a second exemplary embodiment of the present disclosure.

FIG. 6 is a schematic diagram showing a configuration of a transmission line in a microwave treatment device in accordance with a fourth exemplary embodiment of the present disclosure.

### DESCRIPTION OF EMBODIMENTS

A microwave treatment device of a first aspect of the present disclosure includes a plurality of radiation parts, a transmission line, and a plurality of feeding parts. The plurality of radiation parts includes a first radiation part, a second radiation part, and a third radiation part, and radiates a microwave. The transmission line has a loop line structure provided with a plurality of branch parts including a first branch part, a second branch part, and a third branch part. The transmission line transmits the microwave to the first radiation part, the second radiation part, and the third radiation part respectively connected to the first branch part, the second branch part, and the third branch part. The plurality of feeding parts includes a first feeding part and a second feeding part arranged in the transmission line at an interval of ¼ or less of a wavelength of the microwave, and transmits the microwave to the transmission line.

In the microwave treatment device of a second aspect of the present disclosure, in addition to the first aspect, the first branch part is arranged at an equal interval from the first feeding part and the second feeding part; and the second branch part and the third branch part are separately arranged apart at ¼ of the wavelength of the microwave from the first branch part.

In a microwave treatment device in accordance with a third aspect of the present disclosure, in addition to the first aspect, the first feeding part and the second feeding part transmit the microwave vertically with respect to the transmission line.

In a microwave treatment device in accordance with a fourth aspect of the present disclosure, a radiation part that radiates the microwave is selectively switched among the plurality of radiation parts by controlling a phase difference between the two microwaves supplied from the first feeding part and the second feeding part to the transmission line in the first aspect.

In a microwave treatment device in accordance with a fifth aspect of the present disclosure, in addition to the first aspect, the first feeding part and the second feeding part are arranged at an interval of ¼ of the wavelength of the microwave.

In a microwave treatment device in accordance with a sixth aspect of the present disclosure, in addition to the first aspect, a length of one circumference of the transmission line is set at a sum of an integral multiple of the wavelength of a microwave, a half of the wavelength of the microwave, and twice of the interval between the first feeding part and the second feeding part.

In a microwave treatment device in accordance with a seventh aspect of the present disclosure, in addition to the first aspect, the transmission line has an elliptical shape including a straight portion and a curved portion.

A microwave treatment device in accordance with an eighth aspect of the present disclosure includes a first feeding control circuit and a second feeding control circuit in addition to the first aspect. Each of the first feeding control circuit and the second feeding control circuit includes the plurality of feeding parts, the plurality of branch parts, the plurality of radiation parts, and the transmission line. The first radiation part included in the first feeding control circuit is common to the first radiation part included in the second feeding control circuit.

A microwave treatment device in accordance with a ninth aspect of the present disclosure, in addition to the eighth aspect, further includes a heating chamber for accommodating a heating target object. The first radiation part is disposed below a center portion of a mount table of the heating chamber.

In a microwave treatment device in accordance with a tenth aspect of the present disclosure, in addition to the eighth aspect, the first radiation part is a patch antenna, and the first feeding control circuit and the second feeding control circuit transmit the microwave vertically with respect to the first radiation part.

In a microwave treatment device in accordance with an eleventh aspect of the present disclosure, in addition to the first aspect, the second radiation part includes a plurality of radiation parts, and the third radiation part includes a plurality of radiation parts.

Hereinafter, the exemplary embodiment of the present disclosure is described with reference to drawings. In the description, the same reference marks are given to the same or corresponding parts, and duplicate description thereof are omitted.

### First Exemplary Embodiment

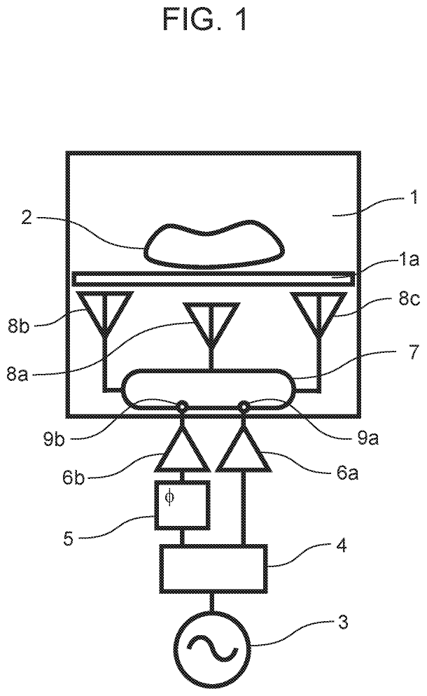

FIG. 1 is a schematic diagram showing a configuration of microwave treatment device 50 in accordance with a first exemplary embodiment of the present disclosure. As shown in FIG. 1, the microwave treatment device of this exemplary embodiment includes heating chamber 1, oscillation part 3, distributing part 4, phase variable part 5, amplifiers 6a and 6b, transmission line 7, and radiation parts 8a, 8b, and 8c.

Heating chamber 1 accommodates heating target object 2, for example, food. Oscillation part 3 includes, for example, an oscillation source formed of, for example, a semiconductor, and generates microwaves. Distributing part 4 distributes the microwaves generated by oscillation part 3 into two, and supplies the distributed microwaves to phase variable part 5 and amplifier 6a.

Phase variable part 5 changes the phase of the microwaves distributed by distributing part 4. Amplifier 6a amplifies the microwaves distributed by distributing part 4. Amplifier 6b amplifies the microwaves whose phase has been changed by phase variable part 5.

Feeding parts 9a and 9b are arranged in transmission line 7. The microwave amplified by amplifier 6a is transmitted to transmission line 7 via feeding part 9a. The microwave amplified by amplifier 6b is transmitted to transmission line 7 via feeding part 9b.

Radiation parts 8a, 8b, and 8c radiate the microwaves transmitted via transmission line 7 to the inside of heating chamber 1. Heating target object 2 inside heating chamber 1 is heated by the microwaves radiated by radiation parts 8a, 8b, and 8c.

Transmission line 7 and radiation parts 8a, 8b, and 8c are disposed below mount table 1a in heating chamber 1 in which heating target object 2 is mounted.

Radiation parts 8a, 8b, and 8c correspond to the first radiation part, the second radiation part, and the third radiation part, respectively. Feeding parts 9a and 9b correspond to the first feeding part and the second feeding part, respectively.

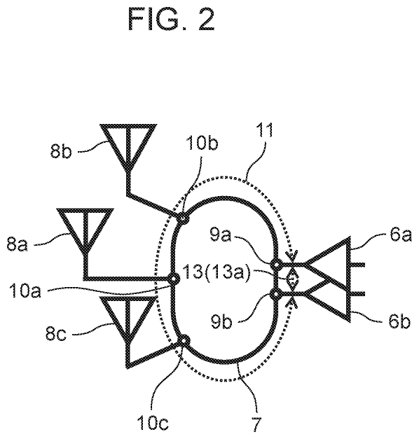

FIG. 2 is a schematic diagram showing a configuration and a line length of transmission line 7 in the microwave treatment device in accordance with this exemplary embodiment. In particular, FIG. 2 shows a path length between feeding parts 9a and 9b. As shown in FIG. 2, transmission line 7 has an elliptical loop line structure including a straight portion and a curved portion. The straight portion of transmission line 7 is provided with branch parts 10a, 10b, and 10c.

The microwaves transmitted to transmission line 7 from feeding parts 9a and 9b are synthesized on transmission line 7. The microwaves synthesized on transmission line 7 are supplied to radiation parts 8a, 8b, and 8c via branch parts 10a, 10b, and 10c. Branch parts 10a, 10b, and 10c correspond to a first branch part, a second branch part, and a third branch part, respectively.

Feeding parts 9a and 9b are provided in adjacent to each other on the straight portion of transmission line 7. In this exemplary embodiment, feeding parts 9a and 9b are arranged at an interval of ¼ or less of the wavelength of the microwave. Feeding parts 9a and 9b transmit microwaves vertically with respect to transmission line 7. That is to say, transmission line 7 has a T-letter shaped coupled-line configuration. Thus, at feeding parts 9a and 9b, the microwaves are branched into two equally.

Operations and actions of the microwave treatment device configured as mentioned above are described.

As shown in FIG. 2, a path between feeding parts 9a and 9b on transmission line 7 includes path 11 that substantially circulates transmission line 7, and path 13 linking feeding parts 9a and 9b at the shortest distance.

When the length of path 13, that is, the interval between feeding part 9a and feeding part 9b is defined as α [mm] (α is ¼ or less of the wavelength of the microwave), the length of path 11 is set at the sum [mm] of an integral multiple of the wavelength of the microwave, a half of the wavelength of the microwave, and a. That is to say, the length of one circumference of transmission line 7 is the sum of the integral multiple of the wavelength of the microwave, a half of the wavelength of the microwave, and twice of the interval between feeding parts 9a and 9b.

Since paths 11 and 13 have the above lengths, two microwaves which have propagated on two paths from feeding part 9a are synthesized in opposite phase at feeding part 9b, and cancel each other (see Table 1). As a result, penetration of the microwaves from feeding part 9a to feeding part 9b can be suppressed. Similarly, penetration of the microwaves from feeding part 9b to feeding part 9a can also be suppressed.

TABLE 1

| From feeding part 9a | | Via | Synthesizing |
|---|---|---|---|
| to feeding part 9b | Via path 11 | path 13 | result |
| Path length | Wavelength of microwave | α [mm] | Cancel |
| | X n (n: integer) + | | |
| | Wavelength of microwave | | |
| | X 1/2 + α [mm] | | |

In this way, since the penetration of the microwaves between feeding parts 9a and 9b can be suppressed, excessive inflow of electric power to amplifiers 6a and 6b is prevented, thus preventing amplifiers 6a and 6b from being damaged. Thus, a loss of the supplied electric power is suppressed, and the radiation efficiency can be enhanced. As a result, highly efficient heating can be achieved.

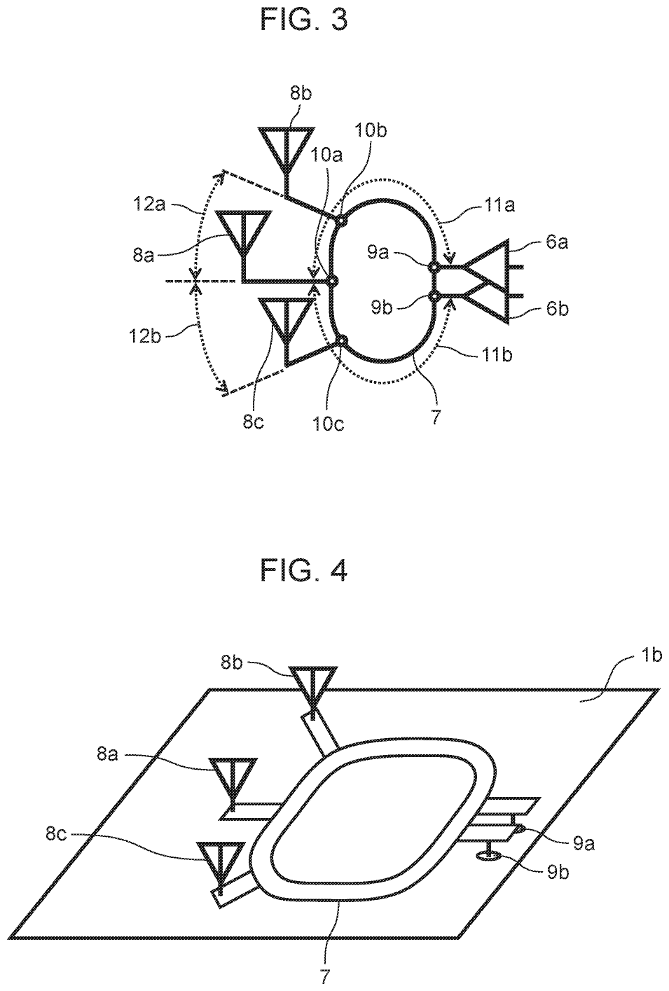

FIG. 3 is a schematic diagram showing a configuration and a line length of transmission line 7 in the microwave treatment device-in accordance with this exemplary embodiment. In particular, FIG. 3 shows a path length between the feeding part and the branch part, and a path length between the branch part and the branch part.

As shown in FIG. 3, a length of transmission line 7 between feeding part 9a and branch part 10a is set at phase length 11a. The length of transmission line 7 between feeding part 9b and branch part 10a is set at phase length 11b. The length of transmission line 7 between branch part 10a and branch part 10b is set at phase length 12a. The length of transmission line 7 between branch part 10a and branch part 10c is set at phase length 12b.

The phase length is a value obtained by substituting the length L (mm) of the transmission line and the wavelength λ (mm) of a microwave propagating through the transmission line into the following equation 1.

The unit of the phase length is “degree.”

$$\begin{matrix}[ Math . 1 ] & \\ Phase length [ deg . ] = ( \frac{Length L [ mm ]}{Wavelength λ [ mm ]} - INT ( \frac{Length L [ mm ]}{Wavelength λ [ mm ]} ) ) \times 360 \\ ( INT function rounds the argument to the nearest integer . ) & \end{matrix}$$

Phase length 11a is set at 0 degrees. Thus, when a microwave propagates through path 11 between feeding part 9a and branch part 10a, the phase of the microwave after propagation is the same as the phase of the microwave before propagation. Phase length 11b is also set at 0 degrees. Thus, when a microwave propagates through path 11 between feeding part 9b and branch part 10a, the phase of the microwave after propagation is the same as the phase of the microwave before propagation.

Phase length 12a is set at 90 degrees. Thus, when a microwave propagates through path 11 between branch part 10a and branch part 10b, the phase of the microwave after propagation advances by 90 degrees from the phase of the microwave before propagation. Phase length 12b is also set at 90 degrees. Thus, when a microwave propagates through path 11 between branch part 10a and branch part 10c, the phase of the microwave after propagation advances by 90 degrees from the phase of the microwave before propagation.

Table 2 shows an action of transmission line 7 in a case where the microwave amplified by amplifier 6a has the same phase as that of the microwave amplified by amplifier 6b.

TABLE 2

| Same phase at | From amplifier 6a | From amplifier 6b | Synthesizing |
|---|---|---|---|
| amplifiers 6a and 6b | (=0 [deg.]) | (=0 [deg.]) | result |
| To branch part 10a | +Phase length11a | +Phase length11b | Overlap |
| | (=0 [deg.]) | (=0 [deg.]) | |
| To branch part 10b | +Phase length11a | +Phase length11a | Cancel |
| | −Phase length12a | +Phase length12a | |
| | (=−90 [deg.]) | (=90 [deg.]) | |
| To branch part 10c | +Phase length11a | +Phase length11a | Cancel |
| | +Phase length12b | −Phase length12b | |
| | (=90 [deg.]) | (=−90 [deg.]) | |

The phase length from amplifier 6a to feeding part 9a and the phase length from amplifier 6b to feeding part 9b are 0 degrees. Accordingly, the both phase length from amplifier 6a to branch part 10a and the phase length from amplifier 6b to branch part 10a are 0 degrees.

Therefore, when the microwave amplified by amplifier 6a and the microwave amplified by amplifier 6b have the same phase, two microwaves overlap each other and are amplified in branch part 10a (see Table 2). As a result, the amplified microwave is supplied to radiation part 8a.

Since phase length 12a is 90 degrees, the phase length from amplifier 6a to branch part 10b is decreased by 90 degrees from the phase length (0 degrees) from amplifier 6a to branch part 10a. On the other hand, the phase length from amplifier 6b to branch part 10b is increased by 90 degrees from the phase length (0 degrees) from amplifier 6b to branch part 10a. Therefore, the phase length from amplifier 6b to branch part 10b is larger by 180 degrees than the phase length from amplifier 6a to branch part 10b.

Therefore, when the microwave amplified by amplifier 6a and the microwave amplified by amplifier 6b have the same phase, the two microwaves cancel each other in branch part 10b (see Table 2). As a result, a microwave is not supplied to radiation part 8b.

Similarly, in branch part 10c, two microwaves cancel each other, and a microwave is not supplied to radiation part 8c. In this way, when the microwave amplified by amplifier 6a and the microwave amplified by amplifier 6b have the same phase, high-frequency power is only selectively supplied to radiation part 8a.

Table 3 shows actions of transmission line 7 in a case where the microwave amplified by amplifier 6a has a phase opposite to that of the microwave amplified by amplifier 6b.

TABLE 3

| Opposite phase at | From amplifier 6a | From amplifier 6b | Synthesizing |
|---|---|---|---|
| amplifier 6a, 6b | (0 [deg.]) | (180 [deg.]) | result |
| To branch part 10a | +Phase length11a | +Phase length11b | Cancel |
| | (=0 [deg.]) | (=180 [deg.]) | |
| To branch part 10b | +Phase length11a | +Phase length11a | Overlap |
| | −Phase length12a | +Phase length12a | |
| | (=−90 [deg.]) | (=270 [deg.]) | |
| To branch part 10c | +Phase length11a | +Phase length11a | Overlap |
| | +Phase length12b | −Phase length12b | |
| | (=90 [deg.]) | (=90 [deg.]) | |

When the microwave amplified by amplifier 6a and the microwave amplified by amplifier 6b have an opposite phase, transmission line 7 acts oppositely to the case shown in Table 2.

That is to say, in branch parts 10b and 10c, two microwaves overlap each other and are amplified (see Table 3). As a result, the amplified microwaves are supplied to radiation parts 8b and 8c. In branch part 10a, two microwaves cancel each other (see Table 3). As a result, a microwave is not supplied to radiation part 8a.

In this way, when the microwave amplified by amplifier 6a and the microwave amplified by amplifier 6b have an opposite phase, the high-frequency power is selectively supplied to radiation parts 8b and 8c.

In this exemplary embodiment, a phase difference is controlled between the microwave amplified by amplifier 6a and the microwave amplified by amplifier 6b, by means of phase variable part 5. Thus, a radiation part that radiates the microwave can be selectively switched among radiation parts 8a to 8c. As a result, the microwave distribution in heating chamber 1 can be intentionally operated.

FIG. 4 is a perspective view of transmission line 7 in the microwave treatment device in accordance with this exemplary embodiment. As shown in FIG. 4, transmission line 7 includes a microstrip line that is disposed adjacent to a wall surface of heating chamber 1. Feeding parts 9a and 9b are formed by connecting coaxial core lines penetrating through wall surface 1b of heating chamber 1 to transmission line 7. Branch parts 10a, 10b, and 10c include microstrip lines branched from transmission line 7. Radiation parts 8a, 8b, and 8c are an antenna including a microstrip line.

In this exemplary embodiment, oscillation part 3 include an oscillation source formed of a semiconductor. However, oscillation part 3 may be formed of other oscillation sources such as magnetron.

### Second Exemplary Embodiment

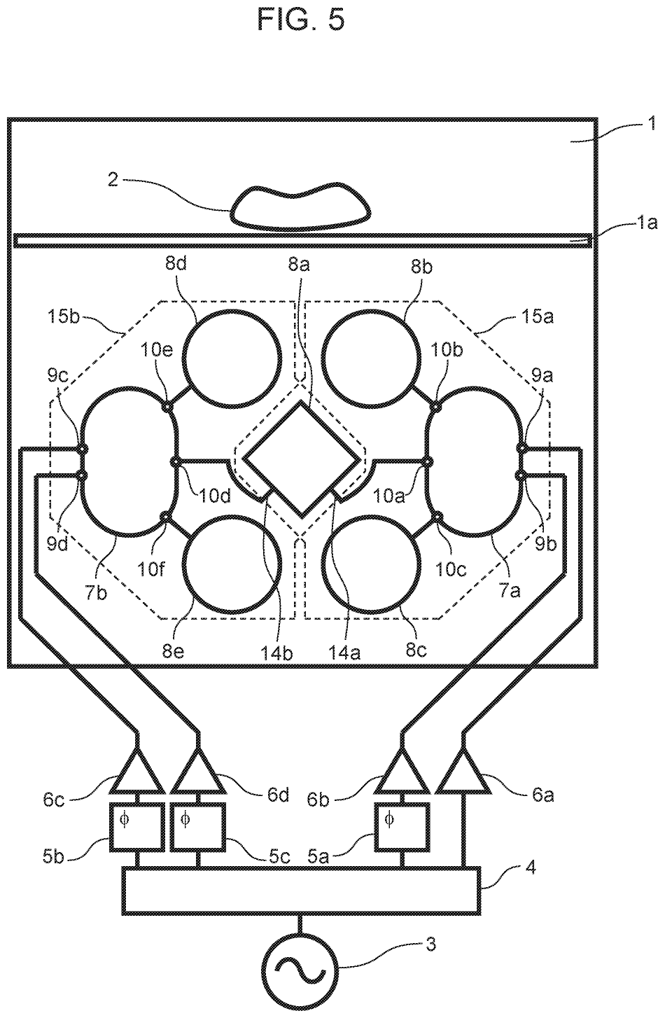

FIG. 5 is a schematic diagram showing a configuration of a transmission line in a microwave treatment device in accordance with a second exemplary embodiment of the present disclosure.

As shown in FIG. 5, the microwave treatment device of this exemplary embodiment includes feeding control circuit 15a and feeding control circuit 15b. Feeding control circuits 15a and 15b are respectively arranged at the right side and left side below mount table 1a of heating chamber 1.

Feeding control circuit 15a includes feeding part 9a, feeding part 9b, transmission line 7a, radiation part 8a, radiation part 8b, and radiation part 8c. Feeding control circuit 15b includes feeding part 9c, feeding part 9d, transmission line 7b having a loop line structure, radiation part 8a, radiation part 8d, and radiation part 8e.

Feeding control circuits 15a and 15b share radiation part 8a, and both feeding control circuits 15a and 15b can transmit a microwave to radiation part 8a. Radiation part 8a is disposed below the center of mount table 1a.

Transmission lines 7a and 7b have an elliptical loop line structure including a straight portion and a curved portion similar to transmission line 7 of the first exemplary embodiment. Feeding parts 9a and 9b are arranged in the straight portion of transmission line 7a. Feeding parts 9c and 9d are arranged in the straight portion of transmission line 7b.

Distributing part 4 distributes microwaves generated by oscillation part 3 into four, and supplies the distributed microwaves to phase variable parts 5a, 5b, and 5c and amplifier 6a. Phase variable parts 5a, 5b, and 5c change the phases of the microwaves distributed by distributing part 4.

Amplifier 6a amplifies the microwaves distributed by distributing part 4. Amplifier 6b amplifies the microwaves whose phase has been changed by phase variable part 5a. Amplifier 6c amplifies the microwaves whose phase has been changed by phase variable part 5b. Amplifier 6d amplifies the microwaves whose phase has been changed by phase variable part 5c.

The microwave amplified by amplifier 6a is transmitted to transmission line 7a via feeding part 9a. The microwave amplified by amplifier 6b is transmitted to transmission line 7a via feeding part 9b. The microwave amplified by amplifier 6c is transmitted to transmission line 7b via feeding part 9c. The microwave amplified by amplifier 6d is transmitted to transmission line 7b via feeding part 9d.

Branch part 10a, branch part 10b, and branch part 10c are arranged in the straight portion of transmission line 7a. Branch part 10d, branch part 10e, and branch part 10f are arranged in the straight portion of transmission line 7b.

Microwaves transmitted to transmission line 7a via feeding parts 9a and 9b are synthesized on transmission line 7a. The microwaves synthesized on transmission line 7a are supplied to radiation parts 8a, 8b, and 8c via branch parts 10a, 10b, and 10c.

Microwaves transmitted to transmission line 7b via feeding parts 9c and 9d are synthesized on transmission line 7b. The microwaves synthesized on transmission line 7b are supplied to radiation parts 8a, 8d, and 8e via branch parts 10d, 10e, and 10f.

In this exemplary embodiment, radiation parts 8a, 8b, and 8c correspond to the first radiation part, the second radiation part, and the third radiation part in feeding control circuit 15a, respectively. Feeding parts 9a and 9b correspond to the first radiation part and the second radiation part in feeding control circuit 15a, respectively. Branch parts 10a, 10b, and 10c correspond to the first branch part, the second branch part, and the third branch part in feeding control circuit 15a, respectively.

Radiation parts 8a, 8d, and 8e correspond to the first radiation part, the second radiation part, and the third radiation part in feeding control circuit 15b, respectively. Feeding parts 9c and 9d correspond to the first feeding part and the second feeding part in feeding control circuit 15b, respectively. Branch parts 10d, 10e, and 10f correspond to the first branch part, the second branch part, and the third branch part in feeding control circuit 15b, respectively.

That is to say, the first radiation part in feeding control circuit 15a is common to the first radiation part in feeding control circuit 15b.

Radiation parts 8a to 8e are a patch antenna. Radiation part 8a has a square shape. Radiation part 8a has feeding part 14a and feeding part 14b, each of which is arranged to a corresponding one of neighboring two sides. Feeding parts 14a and 14b transmit a microwave vertically with respect to radiation part 8a.

With this configuration, two microwaves transmitted to radiation part 8a have excitation directions orthogonal to each other, and do not interfere with each other. This can suppress penetration of microwaves between feeding control circuits 15a and 15b.

Note here that although not shown exactly in FIG. 5, radiation parts 8a to 8c are arranged in parallel to mount table 1a.

In this exemplary embodiment, a phase difference is controlled between the microwave amplified by amplifier 6a and the microwave amplified by amplifier 6b, by means of phase variable part 5a. Thus, a radiation part that radiates the microwave can be selectively switched among radiation parts 8a, 8b, and 8c. As a result, the microwave distribution at the right side in heating chamber 1 can be intentionally operated.

A phase difference is controlled between the microwave amplified by amplifier 6c and the microwave amplified by amplifier 6d, by means of phase variable parts 5b and 5c. Thus, a radiation part that radiates the microwave can be selectively switched among radiation parts 8a, 8d, and 8e. As a result, the microwave distribution at the left side in heating chamber 1 can be intentionally operated.

Furthermore, by means of phase variable parts 5b and 5c, the phase of the microwaves amplified by amplifiers 6c and 6d can be made to be different from the phase of the microwaves amplified by amplifiers 6a and 6b.

### Third Exemplary Embodiment

Next, a microwave treatment device in accordance with a third exemplary embodiment of the present disclosure is described. The microwave treatment device of this exemplary embodiment has substantially the same configurations as those of the first exemplary embodiment shown in FIGS. 1 to 3.

This exemplary embodiment is different from the first exemplary embodiment in that path 13 in transmission line 7, that is, an interval between feeding parts 9a and 9b, has a length of ¼ of the wavelength of the microwave. Hereinafter, with reference to FIG. 2, the microwave treatment device of this exemplary embodiment is described.

Table 4 shows actions of transmission line 7 in a case where the microwave amplified by amplifier 6a has the same phase as that of the microwave amplified by amplifier 6b.

TABLE 4

| Same phase at | From amplifier 6a | From amplifier 6b | Synthesizing |
|---|---|---|---|
| amplifiers 6a and 6b | (=0 [deg.]) | (=0 [deg.]) | result |
| To feeding part 9a | (0 [deg.]) | +Phase length13a | Overlap |
| | | (=90 [deg.]) | |
| To feeding part 9b | +Phase length13a | (0 [deg.]) | Overlap |
| | (=90 [deg.]) | | |

Since the length of path 13 is ¼ of the wavelength of the microwave, phase length 13a of path 13 is 90 degrees. As described above, the phase length from amplifier 6a to feeding part 9a and the phase length from amplifier 6b to feeding part 9b are 0 degrees.

Therefore, as shown in Table 4, the phase of the microwave from amplifier 6b advances by 90 degrees at feeding part 9a via path 13. The microwave from amplifier 6b is synthesized with the microwave from amplifier 6a in power feeding section 9a. The microwaves synthesized at power feeding section 9a propagate counterclockwise on path 11.

Similarly, the phase from amplifier 6a advances by 90 degrees at feeding part 9b via path 13. The microwaves from amplifier 6a is synthesized with the microwave from amplifier 6b at feeding part 9b. The microwaves synthesized at feeding part 9b propagates clockwise on path 11. Thus, when amplifiers 6a and 6b supply microwaves having the same phase, two equal microwaves are transmitted from feeding parts 9a and 9b to path 11.

Table 5 shows actions of transmission line 7 in a case where the microwave amplified by amplifier 6b has a phase that advances by 90 degrees with respect to the microwave amplified by amplifier 6a.

TABLE 5

| Phase difference | From | From | |
|---|---|---|---|
| of 90 deg. at | amplifier 6a | amplifier 6b | Synthesizing |
| amplifiers 6a and 6b | (0 [deg.]) | (90 [deg.]) | result |
| To feeding part 9a | (0 [deg.]) | +Phase length13a | Cancel |
| | | (=180 [deg.]) | |
| To feeding part 9b | +Phase length13a | (90 [deg.]) | Overlap |
| | (=90 [deg.]) | | |

As shown in Table 5, the phase of the microwave from amplifier 6b advances by 90 degrees at feeding part 9a via path 13. Therefore, at feeding part 9a, the microwave from amplifier 6b has a phase opposite to that of the microwave from amplifier 6a. As a result, these microwaves are synthesized at feeding part 9a and cancel each other, and does not propagate on path 11.

On the other hand, the phase of the microwave from amplifier 6a advances by 90 degrees at feeding part 9b via path 13. Therefore, at feeding part 9b, the microwave from amplifier 6a has the same phase as that of the microwave from amplifier 6b. As a result, these microwaves overlap each other and are amplified at feeding part 9b. The microwaves synthesized at feeding part 9b propagate clockwise on path 11.

In this way, when the microwave amplified by amplifier 6b has a phase that advances by 90 degrees with respect to the microwave amplified by amplifier 6a, the amplified microwave propagates clockwise from feeding part 9b clockwise on path 11. This microwave is mainly supplied to radiation part 8c that is the closest from feeding part 9b.

Table 6 shows actions of transmission line 7 in a case where the microwave amplified by amplifier 6b has a phase that delays from the microwave amplified by amplifier 6a.

TABLE 6

| Phase difference | From | From | |
|---|---|---|---|
| of 90 deg. at | amplifier 6a | amplifier 6b | Synthesizing |
| amplifiers 6a and 6b | (0 [deg.]) | (−90 [deg.]) | result |
| To feeding part 9a | (0 [deg.]) | +Phase length13a | Overlap |
| | | (=0 [deg.]) | |
| To feeding part 9b | +Phase length13a | (−90 [deg.]) | Cancel |
| | (=90 [deg.]) | | |

As shown in Table 6, the phase of the microwave from amplifier 6b advances by 90 degrees at feeding part 9a via path 13. Therefore, at feeding part 9a, the microwave from amplifier 6b has the same phase as that of the microwave from amplifier 6a. As a result, these microwaves overlap each other and amplified at feeding part 9a. The microwaves synthesized at feeding part 9a propagate counterclockwise on path 11.

On the other hand, the phase of the microwave from amplifier 6a advances by 90 degrees at feeding part 9b via path 13. Therefore, at feeding part 6b, the microwave from amplifier 6a has a phase opposite to that of the microwave from amplifier 6b. As a result, these microwaves are synthesized at feeding part 9b and cancel each other, and does not propagates on path 11.

In this way, when the microwave amplified by amplifier 6b has a phase that is delayed by 90 degrees with respect to the microwave amplified by amplifier 6a, the amplified microwave propagates counterclockwise from feeding part 9a on path 11. This microwave is mainly supplied to radiation part 8a closest to feeding part 9a.

### Fourth Exemplary Embodiment

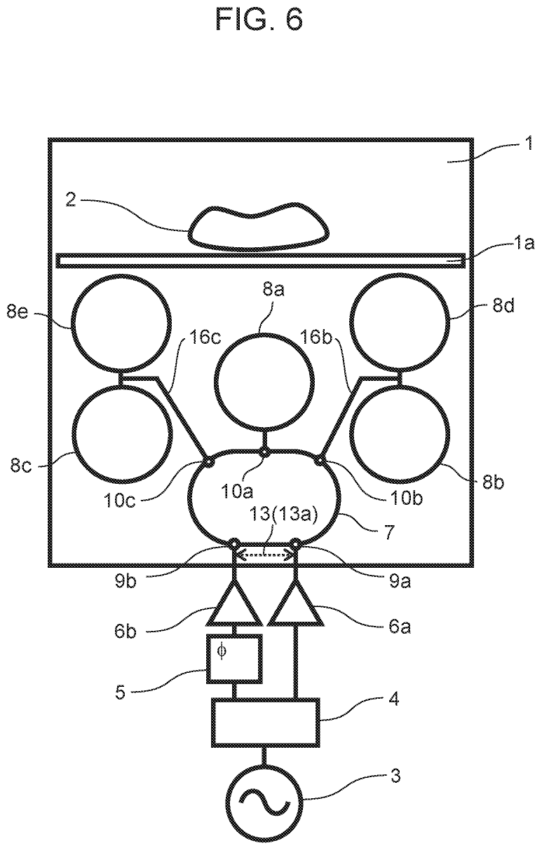

FIG. 6 is a schematic diagram showing a configuration of transmission line 7 in a microwave treatment device in accordance with a fourth exemplary embodiment of the present disclosure.

As shown in FIG. 6, the microwave treatment device of this exemplary embodiment includes transmission line 7 and radiation parts 8a, 8b, 8c, 8d, and 8e, which are arranged below mount table 1a of heating chamber 1. Radiation part 8a is disposed in the center portion. Radiation parts 8b and 8d are arranged at right side. Radiation parts 8c and 8e are arranged at left side. Radiation parts 8a to 8e are a patch antenna.

Radiation part 8a is connected to branch part 10a of transmission line 7. Transmission line 16b branched into two is connected to branch part 10b of transmission line 7. Each of radiation part 8b and radiation part 8d is connected to the corresponding one of two branched portions of transmission line 16b. Transmission line 16c branched into two is connected to branch part 10c of transmission line 7. Each of radiation part 8c and radiation part 8e is connected to the corresponding one of two branched portions of transmission line 16c.

In this exemplary embodiment, radiation part 8a corresponds to the first radiation part. Radiation parts 8b and 8d correspond to the second radiation part. Radiation parts 8c and 8e correspond to the third radiation part. That is to say, the second radiation part and the third radiation part include a plurality of radiation parts.

Note here that although not exactly shown in FIG. 6, radiation parts 8a to 8d are arranged in parallel to mount table 1a.

In this exemplary embodiment, similar to the third exemplary embodiment, a length of path 13 in transmission line 7, that is, the interval between feeding parts 9a and 9b is ¼ of the wavelength of the microwave. Phase length 13a of path 13 is 90 degrees.

Therefore, when microwave amplified by amplifier 6b has a phase that advances by 90 degrees with respect to the microwave amplified by amplifier 6a (see Table 5 in the third exemplary embodiment), the microwaves overlapped and amplified are mainly supplied to radiation parts 8c and 8e. As a result, heating target object 2 placed in the vicinity of radiation parts 8c and 8e is strongly heated.

When the microwave amplified by amplifier 6b has a phase that delays by 90 degrees with respect to the microwave amplified by amplifier 6a (see Table 6 in the third exemplary embodiment), the microwaves overlapped and amplified are mainly supplied to radiation parts 8b and 8d. As a result, heating target object 2 placed in the vicinity of radiation parts 8b and 8d is strongly heated.

According to this exemplary embodiment, a phase difference is controlled similar to that in the third exemplary embodiment, the intended wide range of heating distribution can be achieved. As a result, heat objects to be heated having different shapes, types, and amounts can be heated for a short time in a desired state.

### INDUSTRIAL APPLICABILITY

As mentioned above, the microwave treatment device in accordance with the present disclosure can select a radiation part that radiates a microwave among a plurality of radiation parts while penetration of microwave in a plurality of feeding parts is suppressed. Thus, heating efficiency can be improved and the intended heating distribution can be achieved. The present disclosure can be applied to a high-frequency power supply used in a heating device using dielectric heating, a garbage disposer, a plasma generation power supply which is a semiconductor manufacturing device, and the like.

### REFERENCE MARKS IN THE DRAWINGS

1 heating chamber
1a mount table
1b wall surface
2 heating target object
3 oscillation part
4 distributing part
5, 5a, 5b, 5c phase variable part
6a, 6b, 6c, 6d amplifier
7, 7a, 7b, 16b, 16c transmission line
8a, 8b, 8c, 8d, 8e radiation part
9a, 9b, 9c, 9d, 14a, 14b feeding part
10a, 10b, 10c, 10d, 10e, 10f branch part
11, 13 path
11a, 11b, 12a, 12b, 13a phase length
15a, 15b feeding control circuit

1. A microwave treatment device comprising:
a plurality of radiation parts including a first radiation part, a second radiation part, and a third radiation part, and configured to radiate a microwave;
a transmission line having a loop line structure including a plurality of branch parts, the plurality of branch parts including a first branch part, a second branch part, and a third branch part, the transmission line configured to transmit the microwave to the first radiation part, the second radiation part, and the third radiation part respectively connected to the first branch part, the second branch part, and the third branch part; and
a plurality of feeding parts including a first feeding part and a second feeding part arranged in the transmission line at an interval of ¼ or less of a wavelength of the microwave, and configured to transmit the microwave to the transmission line.

2. The microwave treatment device according to claim 1, wherein the first branch part is arranged at an equal interval from the first feeding part and the second feeding part, and the second branch part and the third branch part are separately arranged apart at ¼ of the wavelength from the first branch part.

3. The microwave treatment device according to claim 1, wherein each of the first feeding part and the second feeding part is configured to transmit the microwave vertically with respect to the transmission line.

4. The microwave treatment device according to claim 1, wherein a radiation part that radiates the microwave is selectively switched among the plurality of radiation parts by controlling a phase difference between two microwaves supplied from the first feeding part and the second feeding part to the transmission line.

5. The microwave treatment device according to claim 1, wherein the first feeding part and the second feeding part are arranged at an interval of ¼ of the wavelength.

6. The microwave treatment device according to claim 1, wherein a length of one circumference of the transmission line is set at a sum of an integral multiple of the wavelength, a half of the wavelength, and twice of the interval between the first feeding part and the second feeding part.

7. The microwave treatment device according to claim 1, wherein the transmission line has an elliptical shape including a straight portion and a curved portion.

8. The microwave treatment device according to claim 1, comprising a first feeding control circuit and a second feeding control circuit, wherein each of the first feeding control circuit and the second feeding control circuit includes the plurality of feeding parts, the plurality of branch parts, the plurality of radiation parts, and the transmission line, and the first radiation part included in the first feeding control circuit is common to the first radiation part included in the second feeding control circuit.

9. The microwave treatment device according to claim 8, further comprising a heating chamber configured to accommodate a heating target object, wherein the first radiation part is disposed below a center portion of a mount table of the heating chamber.

10. The microwave treatment device according to claim 8, wherein the first radiation part is a patch antenna, and each of the first feeding control circuit and the second feeding control circuit is configured to transmit the microwave vertically with respect to the first radiation part.

11. The microwave treatment device according to claim 1, wherein the second radiation part includes a plurality of radiation parts, and the third radiation part includes a plurality of radiation parts.
